(19) United States
(12) Patent Application Publication
(10) Pub. No.: US 2006/0231358 A1
(43) Pub. Date: Oct. 19, 2006

(54) Pre-load ring for shock absorber

(75) Inventors: Everett Hall, Farmington Hills, MI (US); Monte G. Williams, Royal Oak, MI (US); Scott Janson, Clinton Township, MI (US); Dave Griffin, Royal Oak, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/107,118

(22) Filed: Apr. 15, 2005

(51) Int. Cl. F16F 9/348

(52) U.S. Cl. 188/282.5; 188/322.15

(57) ABSTRACT

A shock absorber includes a pre-load ring for providing a desired damping characteristic when a piston is being moved outwardly of a hydraulic cylinder. The pre-load ring has a curved surface in contact with a disc valve. A spring bias is applied to hold the pre-load ring against the disc valve. Since the pre-load ring has a curved surface in contact with the disc valve, there is line contact between the pre-load ring and disc valve. As a result, when the disc valve moves away from a port controlled by the disc valve, there is less friction between the disc valve and the pre-load ring.

### BACKGROUND OF THE INVENTION

This application relates to a shock absorber having a pre-load ring for carrying a spring and applying a bias against a valve plate, and wherein the pre-load ring has line contact with the valve plate to reduce friction.

Shock absorbers are utilized in vehicle applications to connect parts that may move relative to each other during operation of the vehicle. As an example, vehicle wheels and a vehicle frame are typically connected by a shock absorber. The vehicle wheels may travel over uneven terrain and move relative to the vehicle frame. The shock absorber dampens the impact on the vehicle frame to improve ride characteristics for vehicle occupants.

Shock absorber design has become relatively sophisticated. Typically, a shock absorber includes a piston moving within a hydraulic cylinder. Flow passages through the piston control the flow of hydraulic fluid between opposed chambers as the piston moves. The piston is attached to either the vehicle frame or the vehicle wheel, and the hydraulic cylinder is attached to the other of the vehicle frame and the vehicle wheel. Thus, as the vehicle wheel moves relative to the vehicle frame, the piston moves within the hydraulic cylinder. The hydraulic fluid flows through the passages in the piston during this movement.

A good deal of design effort goes into controlling damping characteristics provided by the shock absorber, and to provide a desired damping curve. The damping curve may desirably be different when the shock absorber is experiencing rebound and compression movement.

One desirable type of damping curve is a digressive damping curve. One known way to achieve a digressive damping characteristic is by utilizing a disc valve having a pre-load ring that receives springs that hold the pre-load ring against the disc valve. The springs on the pre-load ring apply a force to the disc valve, which can be tailored to achieve the desired curve.

In a known shock absorber utilizing such a pre-load ring, the pre-load ring has a flat surface in planar contact with a surface on the disc valve. As the disc valve opens, there may be undesirable friction between the disc valve and the pre-load ring over this surface area. The present invention seeks to reduce this undesirable friction.

### SUMMARY OF THE INVENTION

In a disclosed embodiment of this invention, a shock absorber includes a pre-load ring receiving a disc spring to bias the pre-load ring against a disc valve. The pre-load ring preferably has a curved outer surface in contact with the disc valve such that there is line contact between the pre-load ring and the disc valve, rather than the prior art planar contact. The line contact allows the disc valve to flex relative to the pre-load ring, and reduces friction.

In other features of this invention, the pre-load ring may include notches to allow leakage of hydraulic fluid into a space between the disc spring and the disc valve.

In other features of this invention, a piston utilized with the invention includes two groups of passages that communicate hydraulic fluid in each direction through the piston. In one example, the two groups of passages are centered on a concentric circle. The piston has stand-offs spaced adjacent the two groups of passages. The disc valve associated with the pre-load ring is spaced from an entrance to one group of passages leading in a direction away from the pre-load ring. Hydraulic fluid can thus move freely into the one group of passages. A valve plate on an opposed side of the piston closes an end of the group of passages until a sufficient force is created to overcome a spring force on the valve plate. Similar stand-offs are provided on this opposed side of the piston, and allow hydraulic fluid into the other group of passages, which are closed by the disc valve.

These and other features of the present invention can be best understood from the following specification and drawings, the following of which is a brief description.

### BRIEF DESCRIPTION OF THE DRAWINGS

FIG. 1 is a cross-sectional view through an inventive shock absorber.

FIG. 2 is a cross-sectional view through an inventive pre-load ring.

FIG. 3A is an end view of the inventive pre-load ring.

FIG. 3B is a view of an opposed end of the inventive pre-load ring.

FIG. 4 is an end view of a piston incorporated into this invention.

### DETAILED DESCRIPTION OF THE PREFERRED EMBODIMENT

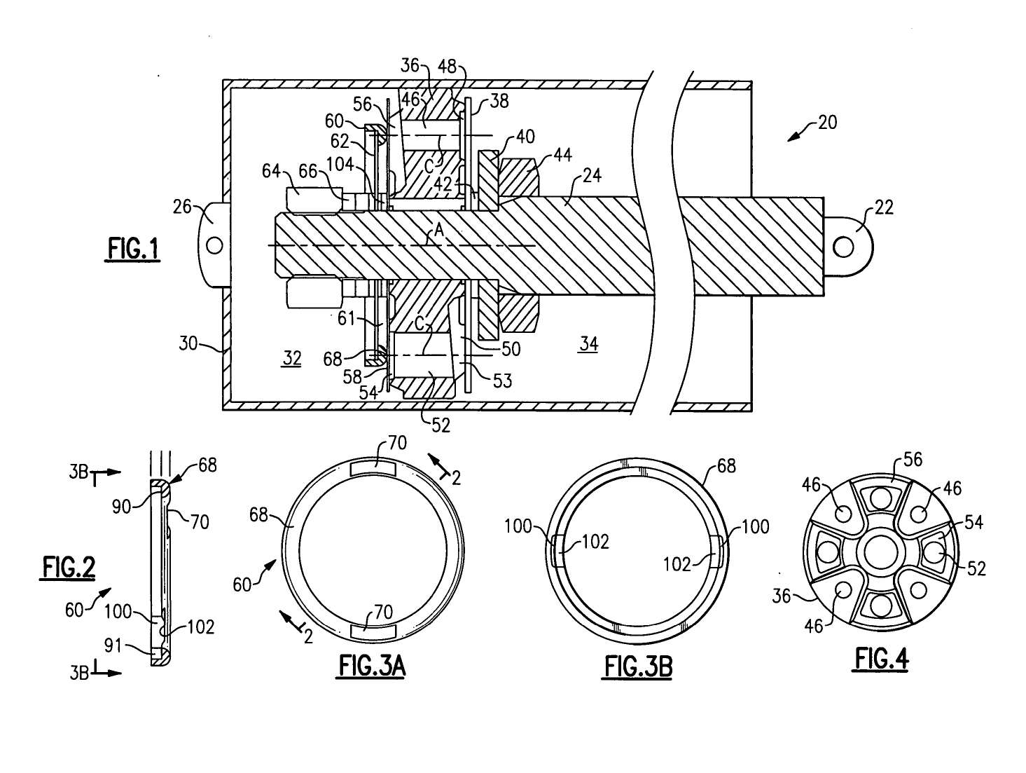

An inventive shock absorber 20 is illustrated in FIG. 1. As known, a connection 22 (shown schematically) is utilized to connect the shock absorber 20 to either a vehicle frame or a vehicle ground-engaging component, such as a wheel. A piston rod 24 extends from the connection 22. Another connection 26 connects a hydraulic cylinder 30 to the vehicle frame or wheel (the other of which is connected to the connection 22).

As can be seen, a piston 36 is connected to the piston rod 24, and divides an interior of the hydraulic cylinder 30 into two hydraulic chambers 32 and 34. A first valve plate 38 is connected by spacers 40 and 42 to the piston rod 24. A rebound bumper 44 is placed on the piston rod 24.

A first set of passages 46 extends through the piston 36 and is closed by the valve plate 38. A plurality of enlarged openings 48 are associated with each of the passages 46. When the piston 36 and piston rod 24 are moving to the left as shown in FIG. 1, the pressure in the chamber 32 will increase, and hydraulic fluid will eventually force the valve plate 38 away from the enlarged openings 48 allowing hydraulic fluid to move from chamber 32 to 34. The opening of the valve plate 38 is carefully designed such that this movement has desirable damping characteristics.

As further shown in FIG. 1, a series of stand-offs 50 extend upwardly from a rightmost face of the piston 36, and provide a stop surface for the valve plate 38 adjacent a second set of passages 52. As shown, the second passages 52 include a passage 53 to allow hydraulic fluid to move from the chamber 34 and into the passages 52. Enlarged openings 54 are formed at a leftmost end of the piston 36, and communicate against a face of a disc valve 58. Stand-offs 56 are adjacent to passages 46 to provide a stop for the disc valve 58. The passages 46 and 52 are formed to be centered on center axes C, which are spaced at an equal distance from a central axis A. Stated another way, the passages 46 and 52 are spaced circumferentially about a single concentric circle through the piston 36.

A pre-load ring 60 receives a disc spring 62 to bias the pre-load ring 60 against the disc valve 58. A space 61 is formed between the disc spring 62 and the disc valve 58. As will be discussed below, leakage passages 70 (see FIG. 2) allow hydraulic fluid to leak into the space 61, and ensure proper operation of the damping characteristics provided by the combination of the pre-load ring 60, the disc spring 62, and the disc valve 58. A pre-load shim stack 104 is placed between the disc spring 62 and the disc valve 58. This pre-load shim stack allows one to better tailor the damping curves. Varying numbers of shims can be utilized to achieve desired results.

As shown, a contact surface 68 between the pre-load ring 60 and the disc valve 58 is provided by a curved surface on the pre-load ring 60. The contact is actually a line contact, which reduces friction as the disc valve 58 flexes away from the enlarged openings 54. A nut 64 is threaded onto an end of the piston rod 24, and optional spacers 66 may also sit against the disc spring 62. When the piston 36 and piston rod 24 are moving to the right as shown in FIG. 1, the hydraulic fluid in the chamber 34 increases in pressure and eventually moves the combination of the disc valve 58, pre-load ring 60 and disc spring 62 away from the enlarged openings 54 such that hydraulic fluid can move from chamber 34 into chamber 32.

While a single disc spring is shown at 62, 58 and 38, it should be understood that additional disc springs and additional spacers may be utilized to control the dimension and spring force as desired.

FIG. 2 shows leakage passages 70 and 100/102, and the curved surface 68. FIG. 3A is an end view and shows that there are a plurality of spaced leakage passages 70. While two leakage passages are shown on each face, greater numbers may be utilized. Examples as high as eight have been considered.

FIG. 3B is an opposed end view, and shows further details of the leakage paths 100 and 102. Essentially, the fluid can leak through the slots 100 along the length of an outer edge 91 of the pre-load ring 60, and into the grooves 102, beneath the disc spring 62, and into the space.

FIG. 4 shows detail of the piston 36, and makes clear that the structure of the stand-offs surrounds the enlarged openings 54. The stand-offs 50 on the opposed side of the piston are formed in a similar manner.

As can be appreciated from FIG. 2, the cross-section of the pre-load ring 60 is generally J-shaped. An end face 90 provides a seat for the disc spring 62, and outer edge 91 provides a guiding surface for an outer peripheral surface of the disc spring 62.

While the present invention shows a pre-load ring 60 at only the leftward end of the piston 36, it is also within the scope of this invention to utilize a second pre-load ring at the right-hand of the piston, if necessary to provide desired damping characteristics.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A shock absorber comprising:
a hydraulic cylinder defining a chamber receiving a piston, said piston connected to a piston rod, said piston and said piston rod being movable within said hydraulic cylinder;
fluid passages extending through said piston, said piston rod extending outwardly of said hydraulic cylinder at a first end of said hydraulic cylinder;
two sets of passages through said piston, with a first set of passages allowing flow of hydraulic fluid from a first chamber defined adjacent said first end of said hydraulic cylinder into a second chamber defined adjacent a second end of said hydraulic cylinder, and a second set of passages allowing flow from said second chamber into said first chamber;
a valve plate attached to said piston on a first face of said piston facing said first end of said hydraulic cylinder to control flow through said second set of passages;
a valve assembly on a second face of said piston facing said second end of said hydraulic cylinder, to control flow of hydraulic fluid through said first set of passages, said valve assembly including a disc valve selectively closing off said first set of passages; and
a pre-load ring applying a bias force to said disc valve, said pre-load ring being connected to said piston rod wherein a contact surface between said pre-load ring and said disc valve is a line contact surface.

2. The shock absorber as set forth in claim 1, wherein a disc spring is received within said pre-load ring, and is fixed to said piston rod such that said disc spring applies a bias force to said pre-load ring to hold said disc valve against said first set of passages.

3. The shock absorber as set forth in claim 2, wherein said pre-load ring has vents formed in a face facing said disc valve to allow hydraulic fluid to leak into a space between said disc spring and said disc valve.

4. The shock absorber as set forth in claim 3, wherein said pre-load ring has vents in a second face facing away from said disc valve to also allow hydraulic fluid to leak into said space between said disc spring and said disc valve.

5. The shock absorber as set forth in claim 1, wherein stand-offs are associated with said piston such that hydraulic fluid can move into each of said first and said second sets of passages.

6. The shock absorber as set forth in claim 1, wherein said pre-load ring has a curved surface in contact with said disc valve.

7. The shock absorber as set forth in claim 1, wherein said pre-load ring is generally J-shaped in cross-section.

8. A shock absorber comprising:
a hydraulic cylinder defining a chamber receiving a piston, said piston connected to a piston rod, said piston and said piston rod being movable within said hydraulic cylinder;
fluid passages extending through said piston, said piston rod extending outwardly of said hydraulic cylinder at a first end of said hydraulic cylinder;
two sets of passages through said piston, with a first set of passages allowing flow of hydraulic fluid from a first chamber defined adjacent said first end of said hydraulic cylinder into a second chamber defined adjacent a second end of said hydraulic cylinder, and a second set of passages allowing flow from said second chamber into said first chamber, a valve plate attached to said piston on a first face of said piston facing said first end of said hydraulic cylinder to control flow through said second set of passages;
a valve assembly on a second face of said piston facing said second end of said hydraulic cylinder to control flow of hydraulic fluid through said first set of passages, said valve assembly including a disc valve selectively closing off said first set of passages;
a pre-load ring applying a bias force to said disc valve, said pre-load ring being connected to said piston rod wherein said pre-load ring has a curved surface in contact with said disc valve and wherein said pre-load ring is generally J-shaped in cross-section; and
a disc spring received within said pre-load ring and fixed to said piston rod such that said disc spring applies a bias force to said pre-load ring to hold said disc valve against said first set of passages, said pre-load ring having vents formed in a face facing said disc valve, and vents in an opposed face to allow hydraulic fluid to leak into a space between said disc spring and said disc valve, and wherein stand-offs are associated with said piston such that hydraulic fluid can move into each of said first and said second sets of passages.
